(19) United States
(12) Patent Application Publication
(10) Pub. No.: US 2007/0073561 A1
(43) Pub. Date: Mar. 29, 2007

(54) Intellectual property umbrella captive insurer

(76) Inventors: James E. Malackowski, Chicago, IL (US); Robert Block, Chicago, IL (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/401,095

(22) Filed: Apr. 10, 2006

Related U.S. Application Data
(60) Provisional application No. 60/669,793, filed on Apr. 8, 2005.

(51) Int. Cl. G06Q 40/00

(52) U.S. Cl. 705/4

(57) ABSTRACT

One embodiment of the invention is a proactive intellectual property (IP) risk management tool, such as an intellectual property umbrella captive (IPUC). In some embodiments, execution of the IPUC includes an initial assessment of the IP Value-at-Risk (Phase I); creation and funding of the required structure (Phase II); and implementation of the necessary process and control elements to manage the identified risks (Phase III). Coincident with formation, patent Sale/License-Back (“S/LB”) options as well as reinsurance or umbrella insurance policies preferably exist to enhance or accelerate execution.

### CROSS-REFERENCE TO RELATED APPLICATIONS

This application claims priority from U.S. Provisional Application No. 60/669,793, filed Apr. 8, 2005, titled INTELLECTUAL PROPERTY UMBRELLA CAPTIVE INSURER. The disclosure all of which is incorporated by reference.

### BACKGROUND OF THE INVENTION

1. Field of the Invention

The present invention in various embodiments relates to managing and valuing assets, as well as insuring against risks associated with assets.

2. Background of the Invention

A captive insurance company is basically an insurance company that only insures all or part of the risks of its parent. In other words, it is an enterprise with all the authority to perform as an insurance company, but is organized by a parent company for the express purpose of providing the parent company's insurance. This definition is, however, rather narrow and fails to reflect the way in which captives have developed over the years. A captive may more usefully be described as an insurer that writes risks whose origins are restricted or risks to which it has unique access. In the last 30 years there has been phenomenal growth in the number of captive insurance companies so that today there are well over 4,000 captives worldwide writing more than $20 Billion in premium. These companies have capital and surplus estimated at over $50 Billion. In a move that demonstrates forcibly the emergence of captives into the mainstream of the insurance and risk management arena, the Council of Lloyd's passed a bylaw in November 1998 permitting the establishment of captive operations at Lloyd's.

The greatest stimulus to the development of captives has been the expense or lack of availability of certain types of insurance coverage in the commercial market. Other considerations apply, however, and these have become so important in the minds of risk managers and finance directors that, even when commercial premium rates have been extraordinarily low, the interest in captives has been greater than ever. Generally, captives are formed for various reasons including:

Lower insurance costs: Commercial market insurance premiums must be adequate to meet the cost of claims, but in common with other commercial enterprises. Insurers typically include in the premium an element to provide for their acquisition costs, overheads and profit. This portion of the premium can represent as much as 35% or 40% of the whole. In establishing a captive, the parent seeks to retain the profit within the group rather than see it go to an outside party. A captive may also help reduce insurance costs by charging a premium that more accurately reflects the parent's loss experience.

Cash flow: Apart from pure underwriting profit, insurers rely heavily on investment income. Premiums are typically paid in advance while claims are paid out over a longer period. Until claims become payable, the premium is available for investment. By utilizing a captive, premiums and investment income are retained within the group, and where the captive is domiciled offshore, that investment income may be untaxed. Additionally, the captive may be able to offer a more flexible premium payment plan thereby offering a direct cash flow advantage to the parent.

Risk retention: A company's willingness to retain more of its own risk, particularly by increasing deductible levels, may be frustrated by the inadequate discount offered by insurers to take account of the increased deductible and by the fact that the company is unable to establish reserves to pay future claims. Establishment of a captive can help address both these problems.

Unavailability of coverage: Where the commercial market is unable or unwilling to provide coverage for certain risks or where the price quoted is seen to be unreasonable, a captive may provide the coverage required.

Risk management: A captive can act as a focus for the risk management and risk financing activities of its parent organization. An effective risk management program will result in recognizable profits for the captive. Risk management can be viewed by a captive owner not as a cost centre but as a potentially profitable part of the company's activities. A captive can also be used by a multinational company to set global deductible levels by enabling a local manager to insure with the captive at a level suitable to the size of their own business unit while the captive only buys reinsurance in excess of the level appropriate to the group as a whole.

Access to the reinsurance market: Reinsurers are the international wholesalers of the insurance world. Operating on a lower cost structure than direct insurers they are able to provide coverage at advantageous rates. By using a captive to access the reinsurance market the buyer can more easily determine their own retention levels and structure their program with greater flexibility.

Writing unrelated risks for profit: Apart from writing its parent's risks, a captive may operate as a separate profit centre by writing the risks of third parties. In particular, an organization may wish to sell insurance to existing customers of its core business. For example, retailers may sell extended warranty cover to customers with the risk being carried by the retailer's captive. The claims pattern of this type of business is usually very predictable with a large number of small exposures and can provide the retailer with a valuable additional source of revenue.

Tax minimization and deferral: The tax considerations in forming a captive will depend on the domicile of both the parent and the captive. Integration of a captive as part of an overall tax planning strategy is a complex subject so that professional legal and tax advice may be helpful.

There are now many types of captive insurers, including:

Single-parent captives, underwriting only the risks of related group companies. Diversified captives underwriting unrelated risks in addition to group business. Association captives which underwrite the risks of members of an industry or trade association. Liability risks such as medical malpractice are frequently insured in this way.

Agency captives formed by insurance brokers or agents to allow them to participate in the high-quality risks, which they control.

Rent-a-captives are insurance companies that provide access to captive facilities without the user needing to capitalize their own captive. The user pays a fee for the use of the captive facilities and will be required to provide some form of collateral so that the rent-a-captive is not at risk from any underwriting losses suffered by the user.

Special purpose vehicles (SPV's) are used in risk securitization. They are reinsurance companies that issue reinsurance contracts to their parent and cede the risk to the capital markets by way of a bond issue.

Risk-Retention Groups (RRGs) are liability insurance companies owned by their members. Under the Liability Risk Retention Act (LRRA), RRGs must be domiciled in a state. Once licensed by its state of domicile, an RRG can insure members in all states. Because the LRRA is a federal law, it preempts state regulation, making it much easier for RRGs to operate nationally. As insurance companies, RRGs retain risk. These are excellent vehicles for medical malpractice insurance.

Captives may be established as direct-writing companies issuing policies to, and receiving premiums from, their insureds but the insurance industry is generally highly regulated, and in many jurisdictions, certain risks may only be written by an admitted insurer. Usually, and particularly in the case of smaller captives, it is simpler for the captive to operate as a reinsurer accepting the risks of its parent, which have been insured by a licensed direct-writing company (a ‘fronting company’) and then ceded to the captive. The fronting company will charge a fee for its services and may require a letter of credit to guarantee the captive's ability to pay claims.

In addition to the types of captives, a few of which are outlined above, captives can fall under different tax and regulatory regimes. Captives can be taxed as U.S. companies, or may choose to be taxed as a foreign company. Captives can be formed in several states in the U.S., or can choose from one of several competent offshore jurisdictions.

### SUMMARY OF THE INVENTION

In varying embodiments of the invention, execution of the intellectual property umbrella captive (IPUC) includes an initial assessment of the intellectual property Value-at-Risk (Phase I); creation and funding of the required structure (Phase II); and implementation of the necessary process and control elements to manage the identified risks (Phase III). Coincident with formation, patent Sale/License-Back (“S/LB”) options as well as reinsurance or umbrella insurance policies preferably exist to enhance or accelerate execution. Elements of this process are described in further detail below.

### BRIEF DESCRIPTION OF THE DRAWINGS

FIG. 1 is a diagram of one embodiment of the relationships between the relevant parties and entities.

### DETAILED DESCRIPTION OF THE PREFERRED EMBODIMENT

The value of Intellectual Property (“IP”) assets is increasing concurrent with IP asset volatility. Corporate holders have unprecedented opportunities to monetize IP but are facing commensurately dangerous threats of direct litigation for infringement and shareholder litigation for the mismanagement of valuable corporate assets and opportunities. Boards (and too often senior management) do not readily possess the expertise to manage and protect IP or even to communicate confidently with shareholders about the relevant value at risk. Those few who understand this risk are frustrated by the insurance markets as their currently exists little to no true risk transfer coverage (i.e., traditional insurance for IP risks).

One embodiment to a solution to this problem may be found in a proactive IP risk management tool that is equivalent in scope to recent corporate investment in intellectual asset management (or “IAM”) generally. Although “captive insurance companies” are well known for environmental and other risks, they have not been adopted to manage risks associated with intellectual property.

Preferably, such a solution requires in-depth IP expertise, rigorous valuation, dedicated management, and effective financial controls. In some embodiments, it contemplates arms-length risk transfer at appropriate attachment points to validate strategic assumptions. Tax efficiency may be a factor in IPUC decision-making as it has been in IAM generally, without distorting sound policies. Preferably, this coordinated, layered approach provides boards and shareholders information needed to assess the risk-adjusted IAM returns. This in turn may support client financial reporting and Sarbanes-Oxley compliance objectives and for many companies would demonstrably lower directors and officers (D&O) risk.

One embodiment of an intellectual property umbrella captive (IPUC) would serve to:

Enhance financial reporting transparency through valuation, risk identification, risk quantification and claim tracking;

Concentrate management of IP risk;

Centralize and systematize collection of IP risk data;

Where appropriate, diversify and pool IP risk and/or aggregate IP assets to strengthen offensive or defensive positions;

Increase opportunity to strategically transfer risk through reinsurance;

Establish SEC-compliant reserve for catastrophic losses; and

Obtain tax and time-value benefits associated with well designed captive structures.

Execution

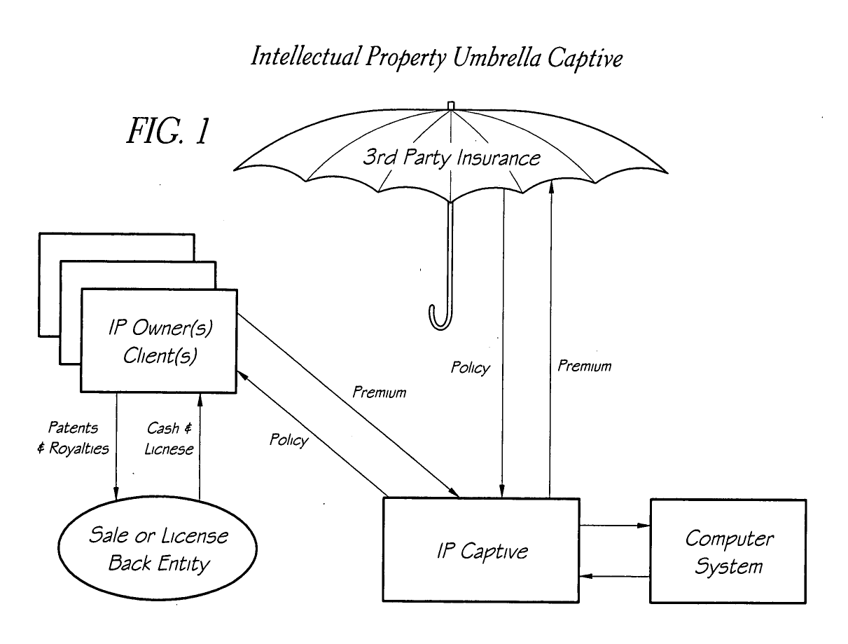

In some embodiments, execution of the IPUC includes an initial assessment of the IP Value-at-Risk (Phase I); creation and funding of the required structure (Phase II); and implementation of the necessary process and control elements to manage the identified risks (Phase III). Coincident with formation, patent Sale/License-Back (“S/LB”) options as well as reinsurance or umbrella insurance policies preferably exist to enhance or accelerate execution. One embodiment of this process is depicted in FIG. 1. Elements of this process are described in further detail below.

Phase I—Perform IP Value-at-Risk Assessment

In one embodiment, implementing an IPUC starts with a comprehensive review of properties, protocols and processes relevant to developing effective risk management. One goal may be to collect and evaluate primary information including an inventory of IP assets and related policies and procedures. In one embodiment, the process comprises the following steps:

Assess client's strategic objectives for its IP portfolio.

Review client's policies concerning patentability and IP protection.

Review and compile detailed summary of Client's IP assets including the following:
Issued and pending patent lists;
Process and control documents for patentability reports and IP committees;
Lists of current and past prolific inventors which might affect the client's core business and related agreements;
Compilation of significant non-traditional IP including contract research.

Review of Client's licenses, cross licenses, nondisclosure and non-compete agreements, joint ventures, and any partnerships related to IP exchange including revenues and costs related to these relationships.

Perform patent-based maintenance value calculation.

Identify primary threats to IP portfolio including:

Third-party risks: competitive vs. “submarine” patents;
First-party risks: invalidity or valuation risk (i.e., risk that patent value will be lower than reported valuations);
D&O risks;
Enforcement costs & risks.

Analysis of reserves and reserving protocols for open claims.

Utilization of current insurance assets.

Client's management of IP counter-party risks (licensing, co-ventures).

Overview of Client's IP D&O Strategies including:
Information flow to the Board on IP issues;
IP disclosures and disclosure protocols.

Determine potential infringement challenges (offensive & defensive) and model damage exposure.

Assess Client's exposure as third-party indemnitor of patent infringement risks.

Calculate maximum adverse movement in IP portfolio within an accepted probability tolerance, including maximum likely tax on liquidity (“IP VAR”). Calculation will be determinative of limits, premium, and scope of coverage.

Phase II—Creation of the Captive Structure

In some embodiments, this phase includes work with captive and actuarial professionals in order to structure the IPUC consistent with all insurance industry requirements. In some embodiments, key elements of the IPUC creation often include:

Model premium based on IP VAR and loss adjustment expense projections;

Determine appropriate reserving policies for open & potential claims;

Determine IBNR (“tail period”) for major claims;

Identify and define extent of insurable (i.e., fortuitous) risks of loss:
Coordinate with existing coverage; insurance & indemnity.
Attention to “other insurance” clauses.
Drafting of subrogation clauses.
Selection & integration of related lines: media, trademark, cyber-exposures.

Determine optimal length of policy terms.

Manuscript policies to cover insurable risks.

Work with outside audit to verify accounting treatment (i.e., deductibility of premium and accrual treatment of multi-year premium payments).

Work with legal & outside audit to develop appropriate financial presentations including treatment in 10Q's and 10K's.

Recommend desired captive structure:
Single-parent;
Group-captive (group members may aggregate patents or establish Patent Investment Entity to improve defensive positions);
Cellular structure;
Rented captive;
Other.

Analyze optimal financial structure, including premium financing, which may include but are not limited to one or more following options:
Option 1: Finance premium with patent sale/license-back, using proceeds to tax efficiently finance premium or otherwise capitalize captive;
Option 2: Transfer intellectual property to captive and fund captive with royalty payments (fixed or floating);
Option 3: Investigate capital markets structures (“CAT” bonds);
Option 4: Conventional premium financing.

Select captive jurisdiction
Trade-off of regulation versus credibility;
Jurisdictional capitalization requirement;
Jurisdictional reporting requirements;
Minimize frictional costs.

Design captive premium investment strategy.

Phase III—IP Process and Control

One goal of this Phase is to identify, create and document Client best practices for managing IP risks holistically as well as to improve coordination and information flows between Legal, Risk Management and research and development (R&D) departments within a company. In some embodiments, elements of this part of the IPUC may include but are not limited to:

Review Client's policy for assessing patent risk in the R&D decision making process including invalidity issues, infringement issues, patent work-around, “double-patenting” and patent matrices.

Evaluate Client's strategic approach to generic challenges.

Coordination & information exchange among:
Internal Patent Law Department;
CTO's Office;
Treasury & CFO;
Outside law firms & consultants.

Develop protocols for integrating IP Risk Management team with IAM function:
Lines of reporting & authority;
Risk Management input into patenting decisions.

Develop IP related Sarbanes-Oxley protocols and control systems.

Identify opportunities to spin-off risk including: contractual indemnities (where client is indemnitee) and third-party bonding:
Identify & classify all contractual indemnities where client is indemnitor or indemnitee
Develop protocols for tapping indemnity contracts including contractual compliance
Leverage vendor relationships to obtain surety bonds for risks that can be efficiently relegated to vendors

Audit and value indemnity contracts where client is indemnitor:
Should contracts be covered in captive;
Are any such contracts “insured contracts” under other available coverage?

Identify and implement further alternative risk transfer mechanisms such as securitization models.

Review Client's policy of managing opportunities for licensing in and out in a non-litigation environment; make IP policy and procedure recommendations for licensing in and out.

Establish organizational structure for executing licenses.

Evaluate Client's potential use of Intellectual Property Holding Companies and other tax efficient strategies for IP transactions and ownership of IP assets.

Identify competitive position in target markets compared to strength of IP portfolio; use patent analytics to map patent portfolio coverage in target markets and map portfolio with strategic objectives to identify technology gaps.

Develop decision tools to compare cost-benefit of R&D vs. licensing in to fill technology gaps:
Assess likelihood of R&D success including timing and costs;
Review competitor's patent positions including blocking patents to focus R&D;
Evaluate market potential and compare to R&D and/or licensing cost.

Use knowledge of competitor's portfolio to assess and manage benefits and risks of license or cross-license; develop methodology to compare licensing in with outright purchase of technology or entire company.

Complete protocols or policies exist for deciding what to patent and when.

Implement process for assessing the relative value of trade secret status vs. patent status.

Instill procedures to identify and capture valuable IP outside of its core strategic IP such as business process method patents.

Comment on Client's enforcement strategy, including litigation risk tolerance and cross-licensing strategies.

Review/enhance policies and procedures of IP review committees including addressing patent disclosures, assigning filing priorities, recommending incentives for employees and other related tasks.

Options

Patent Sale/License-Back

In some embodiments, the invention includes a S/LB component. In order to fully fund the IPUC using an upfront premium, a third party can arrange for the client IP owner to sell and simultaneously license-back a portion of its U.S. patent portfolio, the purpose of which in some embodiments is to generate cash to pay for such premium and also for commercializing select technologies by third party commercialization. Preferably, the sale price of agreed upon patent assets will be consistent with valuations determined by an independent appraiser. This S/LB structure provides a compelling business opportunity for the client over and above the creation of the IPUC consistent with its mission and annual plan for exploiting its intellectual property assets.

Simultaneous with the sale of the patent assets, the client may, in some embodiments, receive a non-exclusive field-of-use back-license to allow for its continued use of the patented technology. The overall S/LB transaction may be structured as a sale for tax purposes and as a financing for accounting purposes. Preferably, payments due by client under the back-license are “hell or high water” in nature and fully deductible for tax purposes, analogous to those made under similar real property leasing arrangements. Preferably, the license-back obligation will be pari-passu in all important respects with the client's senior unsecured debt obligations.

Reinsurance or Umbrella Coverage

Although traditional IP based risk transfer insurance is not readily available, markets do exist to provide additional risk transfer to captive structures through reinsurance, layered captives or “umbrella” policies. Investigation of these options may include but is not limited to the following steps:

Price & place reinsurance:
Limits (ideally 100-200% of Captive retention);
Premium levels;
Policy—following form on primary or restricted;
Reporting requirements plus claims and settlement controls;
Additional level of financial control and risk transfer to protect shareholder value;

Diversify risk with other captives:
Reinsurance layers;
Integrated risk swaps (correlated to other financial returns);
Pursue asset (patent) aggregation strategies inter-captive;
Utilize S/LB funding across multiple portfolios (depending on availability and timing of capital loss carry-forwards) to enhance efficiency.

It should be understood that the invention may include one or any combination of the phases described above. This disclosure also incorporates the following by reference: U.S. Patent Publication Nos. 2001/0042034; 2003/0046105; 2003/0061064; and 2002/0138384.

In some embodiments, it is contemplated that the process steps described herein may be implemented within, or using, software modules (programs) that are executed by one or more general purpose computers. In these embodiments, the software modules may be stored on or within any suitable computer-readable medium. It should be understood that the various steps may alternatively be implemented in-whole or in-part within specially designed hardware.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above.

What is claimed is:

1. A method to implement intellectual property umbrella captive comprising:
performing an intellectual property Value-at-Risk Assessment to identify risks related to intellectual property;
creating a captive structure; and
enhancing a process and control to manage the risks related to intellectual property.

2. A method according to claim 1 further comprising employing a sale or leaseback transaction.

3. A method according to claim 1 further comprising reinsuring intellectual property umbrella captive.

4. A method according to claim 1 wherein at least one of performing, creating or enhancing is at least partially conducted on a computer.

5. A method according to claim 1 wherein the Value-at-Risk Assessment comprises at least one of:
compiling a detailed database of issued and pending patents; and
performing patent-based maintenance value calculation.

6. A method according to claim 1 wherein enhancing comprises at least one of:
assessing timing, costs and likelihood of researching and developing a technology;
reviewing patent positions of a competitor to calculate a value for the patent positions;
calculating a market potential for the technology; and
computing and comparing a cost-benefit of researching and developing the technology versus licensing-in the technology.
